(19) United States
(12) Patent Application Publication
(10) Pub. No.: US 2012/0128826 A1
(43) Pub. Date: May 24, 2012

(54) NOVEL LOW SODIUM SALT COMPOSITION

(76) Inventor: Sambasiva Rao Chigurupati, Omaha, NE (US)

(21) Appl. No.: 13/247,407

(22) Filed: Sep. 28, 2011

Related U.S. Application Data
(63) Continuation of application No. 13/083,179, filed on Apr. 8, 2011.
(60) Provisional application No. 61/414,939, filed on Nov. 18, 2010.

(51) Int. Cl. A23L 1/237; A23L 1/304; A23P 1/02; A23L 1/302

(52) U.S. Cl. 426/61; 426/649; 426/72

(57) ABSTRACT

The present invention relates to novel and unique low sodium salt compositions and the methods used to make them. The low sodium salt compositions include a combination of sodium chloride and non-sodium chloride without modifiers, flavorants, or masking-agents. The unique low salt compositions of the invention are prepared by superheating the components to or beyond their melting points. Furthermore, the invention relates to the use of the salt composition in the food industry.

### CROSS-REFERENCE TO RELATED APPLICATION

This application claims benefit of U.S. Application No. 61/414,939, filed Nov. 18, 2010, and U.S. Application No. 13/083,179, filed Apr. 8, 2011.

### FIELD OF THE INVENTION

The present invention relates to a low sodium salt composition and the methods used to make it. More particularly, the invention relates to a method of making a salt composition. The composition includes a combination of sodium chloride and a non-sodium chloride without modifiers, flavorants, or masking-agents.

### BACKGROUND OF THE INVENTION

Salt, or sodium chloride (NaCl), is well known. While salt imparts a desirable taste and flavor to food, too much use can result in long term adverse health risks. Because of the proliferation of salt in prepared foods and other products found in a grocery store, many people exceed the average recommended daily intake. Exceeding the recommended daily intake of sodium is a significant risk factor in developing high blood pressure and a cause or contributing factor in the rising incidence of heart disease. As such, medical professionals and governmental authorities recommend a reduction in per capita salt consumption of from about 3450 mg per day to a level of about 2300 mg or less per day.

Dietary Guidelines issued in the U.S. in 2005 suggest a proposed consumption limit of 2300 mg of sodium per day and the National Academy of Science (NAS) even suggests 1500-2300 mg of sodium per day. Health advocates at the American Hear Association and the Centers for Disease Control support changing the sodium limit to 1500 mg in the 2010 Dietary Guidelines. The NAS also recommends a potassium consumption of 4,700 mg per day. Typically potassium consumption is less than half of that level.

Because of these and other reasons, there are a variety of salt substitutes in the market. The classical approach to the production of salt substitutes involves combining the sodium and potassium salts, or occasionally magnesium salts, in various ratios, and adding a wide variety of other modifiers (i.e. additives, flavorants, and masking agents) to this mix. The other additives are generally added to mask or at least partially reduce the generally metallic/bitter taste of potassium that has generally been associated with salt substitutes containing potassium and even magnesium. The processing techniques used to make these products include, among others, simple blending, agglomeration, extrusion cooking, and the like.

Generally, the taste of salt substitute mixtures without sodium chloride is unsatisfactory, so that most mixtures contain at least a portion of common salt. However, even such mixtures produce either a distinct off flavor or an inadequate salt taste, especially when the amount is intended not to differ clearly from the comparable amount of common salt. Taste, functionality and consumer acceptance, not to mention cost, are all challenges in developing low sodium salt compositions and, thus far, no suitable salt replacement exists for all applications, even though the technology is rapidly evolving.

Accordingly, the problem of finding compositions, which have the same appearance as salt, taste sufficiently salty, do not have an off flavor and, function like salt, and at the same time, permit the sodium chloride content to be reduced in an economically feasible manner, continues to exist.

Surprisingly, it has now been found that, with heating a mixture of sodium chloride and a non-sodium chloride to or beyond their respective melting temperatures to form an amalgamation of the two components, the above problem is solved.

### SUMMARY OF THE INVENTION

The present invention is directed to low salt compositions that include sodium chloride and a non-sodium chloride and methods of making thereof. The end product does not impart bitterness or off flavors, and does so uniquely without adding any modifiers. The low salt compositions of the invention include a homogeneous amalgamation of sodium chloride and a chloride that is not sodium chloride. This homogeneous amalgamation imparts a salty taste without the addition of masking agents or flavorants to mask bitterness or off flavors. Additives may be included in the compositions of the invention. Such additives may be included either prior to the heat processing or after heating and cooling the composition. Additives may be included to alter the nutritional value, color, caking, oxidation, or function of the low salt compositions, but these additives are not necessary to mask bitterness or off flavors of the compositions.

The compositions of the invention are prepared by mixing sodium chloride and a non-sodium chloride and heating this mixture to or beyond the melting point of the components. After the components have melted, the melted amalgamation of components is allowed to cool and form a solid mass of the salt composition. Once cooled, the solid amalgamation may be ground into smaller particles by methods known in the art.

The addition of additives to the salt compositions of the present invention may advantageously be included either prior to the heating process or following the heating process. A skilled artisan will recognize that inclusion prior to or after the heating process depends upon the properties of the additive. If the additive is included following the heating and cooling process, it may be included by blending the ground salt composition with the additive.

The compositions of the present invention may be used in place of common salt. For instance, the compositions of the present invention may be used as a salt substitute in the production of products in the food industry, included in seasoning mixtures, and as table salt as well as in other uses. One skilled in the art will recognize the multitude of uses for the salt compositions of the present invention, which are too limitless to enumerate.

### REFERENCE TO COLOR FIGURES

The application file contains at least one photograph executed in color. Copies of this patent application publication with color photographs will be provided by the Office upon request and payment of the necessary fee. The following drawings form part of the present specification and are included to further demonstrate certain aspects of the present invention. The invention may be better understood by reference to one or more of these drawings in combination with the detailed description of specific embodiments presented herein.

### BRIEF DESCRIPTION OF THE DRAWINGS

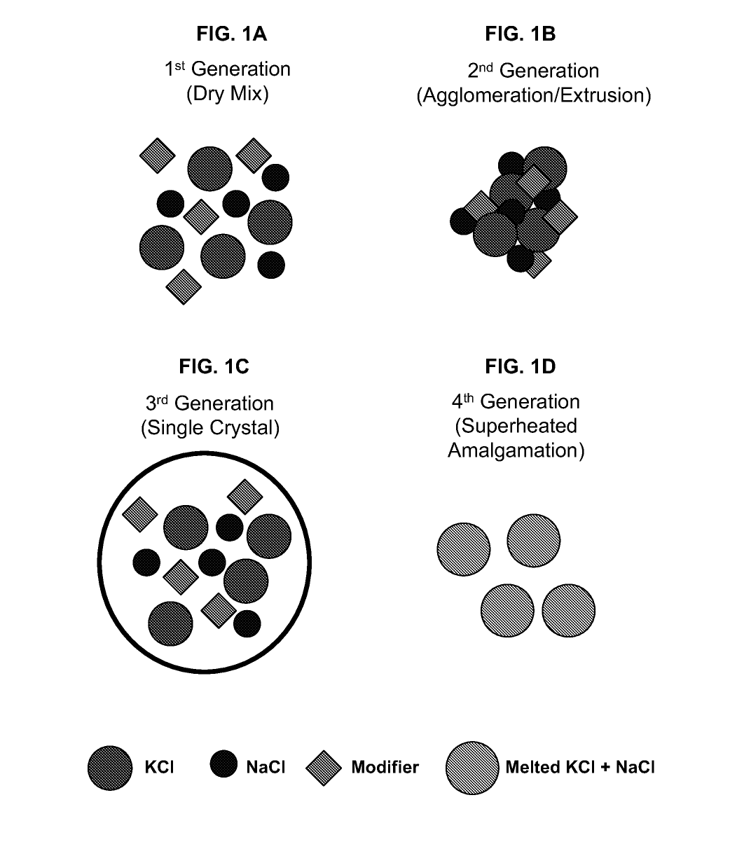

FIG. 1 illustrates the technology and particle arrangement of sodium-replacement compositions known in the art (FIGS. 1A to 1C) in comparison to the composition of the present invention (FIG. 1D).

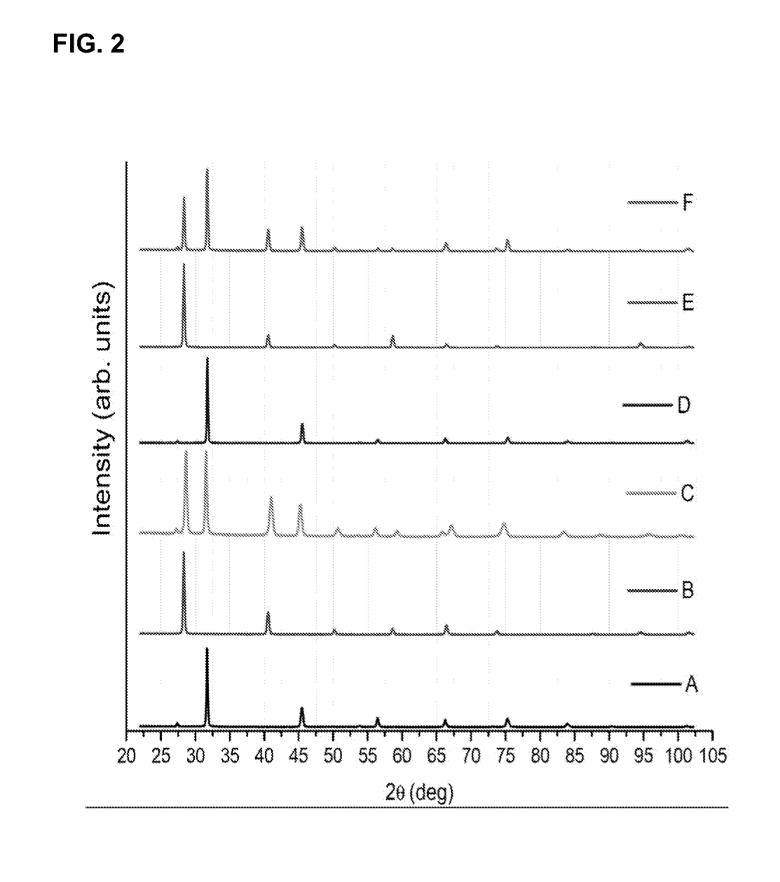

FIG. 2 shows the x-ray diffraction intensity patterns for sodium chloride (FIG. 2A, NaCl), potassium chloride (FIG. 2B, KCl), a blend of sodium chloride and potassium chloride prior to heating (FIG. 2C, NaCl+KCl), melted/cooled sodium chloride (FIG. 2D, NaClₕₘ), melted/cooled potassium chloride (FIG. 2E, KClₕₘ), and an amalgamation of melted sodium chloride and melted potassium chloride (FIG. 2F, NaCl+KClₕₘ).

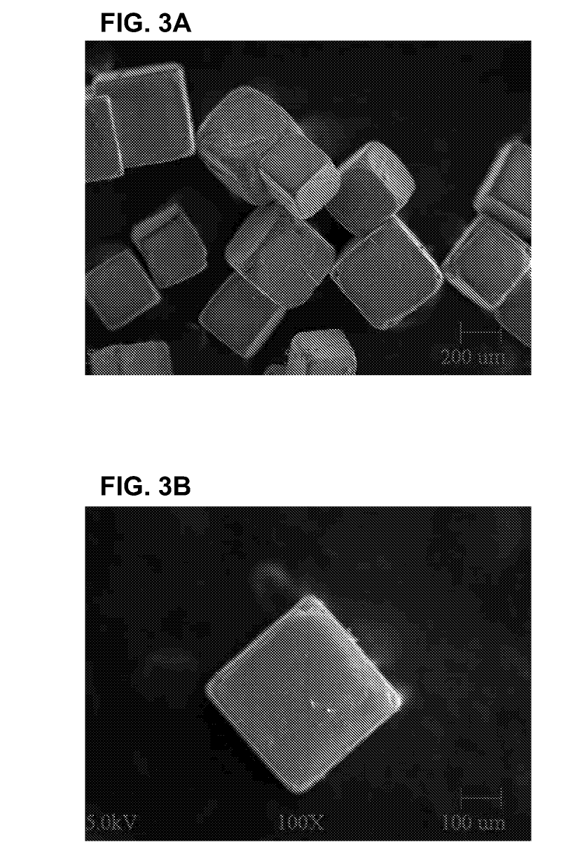

FIG. 3 shows scanning electron microscopy images for sodium chloride (FIG. 3A, 50×; FIG. 3B, 100×).

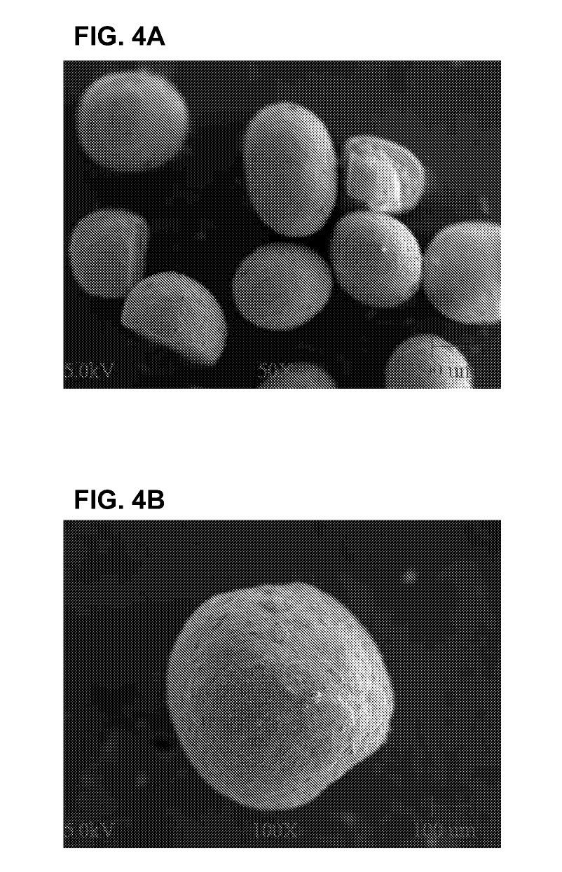

FIG. 4 shows scanning electron microscopy images for potassium chloride (FIG. 4A, 50×; FIG. 4B, 100×).

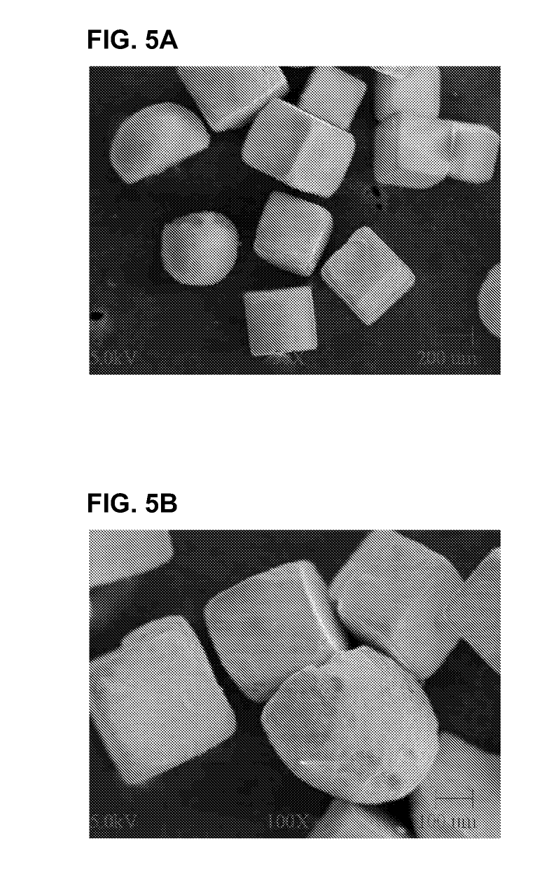

FIG. 5 shows scanning electron microscopy images for a dry mixture of sodium chloride and potassium chloride prior to heating/cooling (FIG. 5A, 50×; FIG. 5B, 100×).

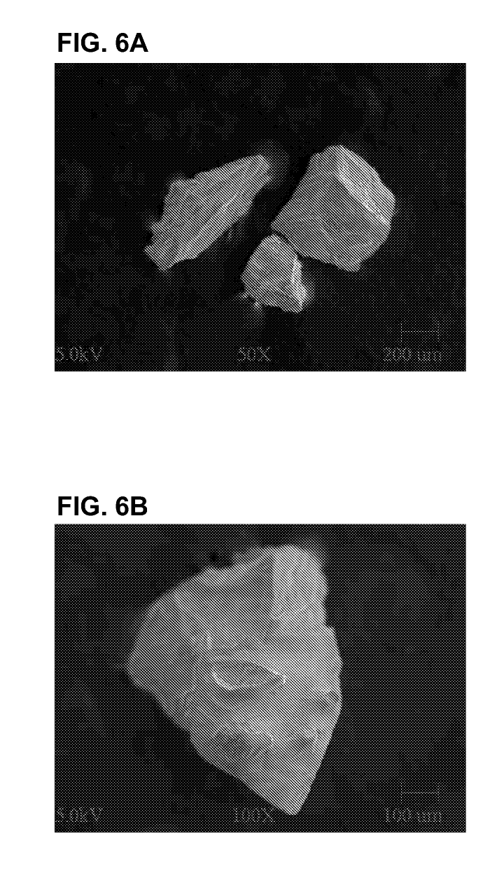

FIG. 6 shows scanning electron microscopy images for the amalgamation of sodium chloride and potassium chloride after melting/cooling (FIG. 6A, 50×; FIG. 6B, 100×).

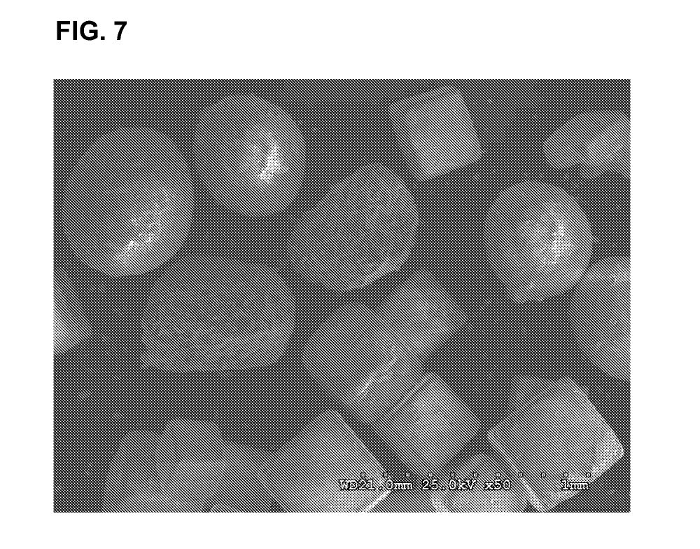

FIG. 7 shows scanning electron microscopy images for a dry mixture of sodium chloride, potassium chloride and magnesium chloride at 50× magnification.

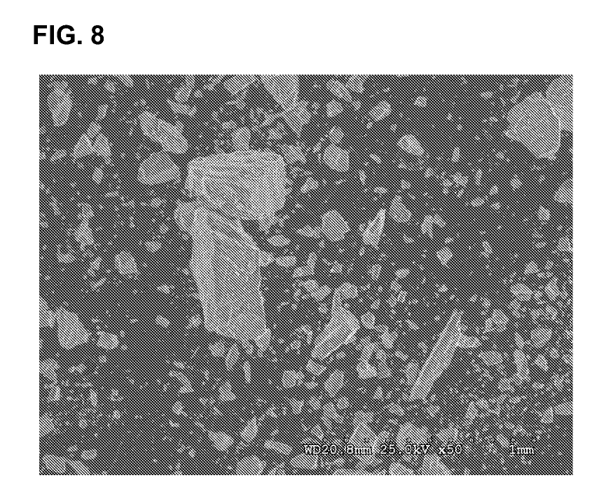

FIG. 8 shows scanning electron microscopy images for the amalgamation of sodium chloride, potassium chloride and magnesium chloride at 50× magnification.

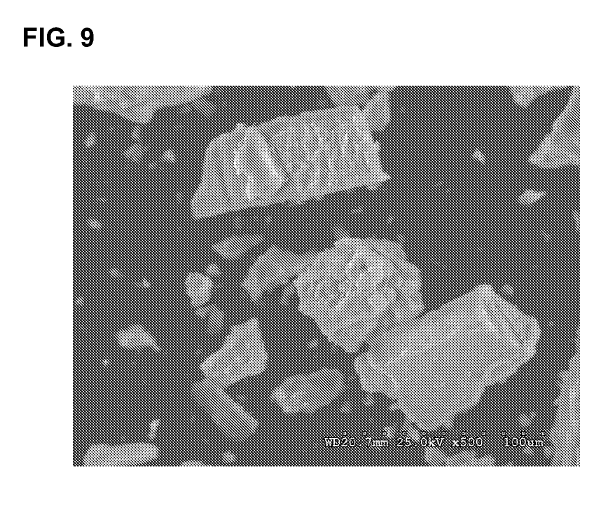

FIG. 9 shows scanning electron microscopy images for the amalgamation of sodium chloride, potassium chloride and magnesium chloride at 500× magnification.

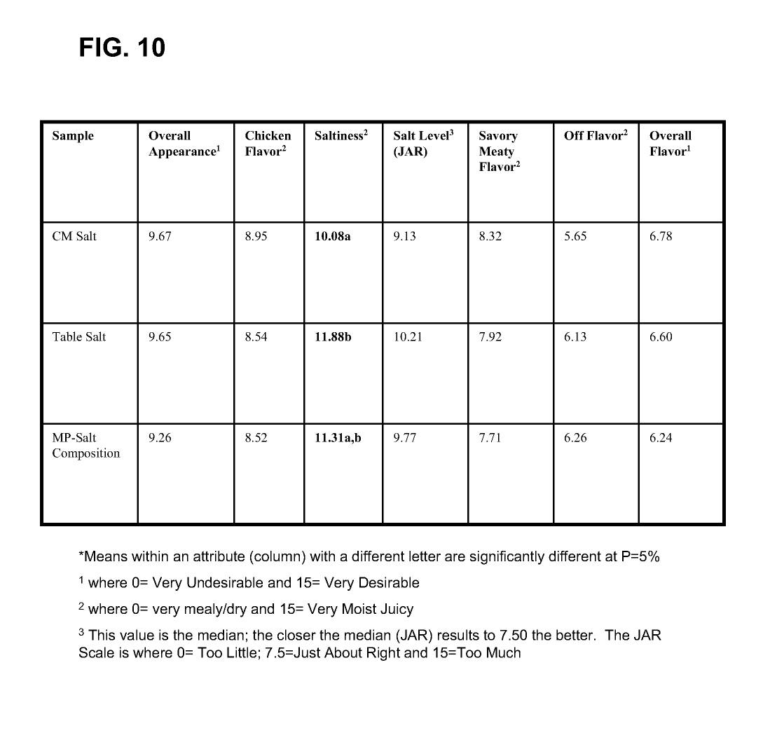

FIG. 10 depicts the sensory test results of appearance and flavor attributes for Chicken Soup Stock.

### DETAILED DESCRIPTION OF THE INVENTION

In accordance with the present invention, a process for making a salt composition having the same appearance and taste as salt, while having a reduced sodium content, and none of the usual modifiers for masking the bitterness of non-sodium chlorides, has been discovered. Related to that process, the resultant salt composition that includes an amalgamation of sodium chloride and a non-sodium chloride, which lacks the need to mask bitterness or off flavors, has been discovered.

The amalgamation of the present invention is a solid homogeneous salt product that contacts taste receptors such that the components are simultaneously received, resulting in a salty taste sensation. Salt compositions of the prior art are primarily dry mixtures and agglomerations of components where each component does not necessarily contact a taste receptor at the same time as the other components. This variation in taste receptor activation where components are not simultaneously received, results in a combination of salty and bitter taste sensations. The combination of salty and bitter taste sensations is perceived as off flavors. Salt compositions of the prior art include modifiers to mask the perception of off flavors.

The surprising and unexpected nature of this discovery can be appreciated by reference to the literature, which abundantly reports the bitter taste of non-sodium chlorides (i.e. potassium chloride and magnesium chloride) and the multiplicity of additives, other than sodium chloride, which have been used to ameliorate this unpleasant taste. The fact that a combination of sodium chloride and non-sodium chloride heated to or beyond their respective melting points to form an amalgamation that lacks the bitterness and off flavors associated with non-sodium chloride containing salt compositions is completely unexpected and entirely unpredictable.

### I. DEFINITIONS

Unless defined otherwise, all technical and scientific terms used herein have the same meaning as is commonly understood by one of ordinary skill in the art. All patents, applications, published applications and other publications are incorporated by reference in their entirety. In the event that there is a plurality of definitions for a term herein, those in this section prevail unless stated otherwise.

As used herein, “agglomeration” or “dry mixture” refers to a combination or mixture of components such that the constituent components in the combination or mixture are indistinguishable from one another upon non-magnified visual inspection.

As used herein, “amalgamation” refers to a combination or mixture of components such that the constituent components in the combination or mixture are indistinguishable from one another upon magnified visual inspection.

As used herein, “dietary supplement” refers to any product that contains a “dietary ingredient” intended to supplement the diet. The “dietary ingredients” in these products may include: vitamins, minerals, herbs or other botanicals, amino acids, and substances such as enzymes, organ tissues, glandulars, and metabolites. Dietary supplements can also be extracts or concentrates.

As used herein, “modifier(s)” refers to additives used to mask the off flavors in reduced sodium compositions. For instance, potassium chloride and magnesium chloride are known to impart bitter, metallic, or other off flavors when used to reduce the sodium content in salt replacement compositions. To mask these off flavors, additives are used. The term “modifier(s)” is used herein to include flavorants, masking agents, organic acids, and other terms used in the art to refer to additives used to alter the taste of a salt composition.

As used herein, “salt”, unless modified by another word (i.e. reduced-salt, potassium salt, calcium salt and the like) or used itself to modify another word (i.e. salt substitute, salt composition and the like), means sodium chloride (NaCl).

### II. COMPOSITIONS

The salt compositions of the present invention, that include sodium chloride and a non-sodium chloride without modifiers, has less sodium, but still has the same taste and appearance of a composition that includes only NaCl.

The salt compositions of the present invention are low sodium salt compositions. In particular, the compositions contain about 10 to 95% lower sodium than regular salt. The compositions contain about 15, 20, 25, 30, 35, 40, 45, 50, 55, 60, 65, 70, 75, 80, 85, 90, or 95% lower sodium than regular salt. Preferably, the compositions contain about 40 to 60% lower sodium than regular salt, and preferably 50% lower sodium than regular salt.

The salt compositions contain sodium chloride and a non-sodium chloride salt. The chloride salt, that is not sodium chloride, may be any single compound such as a chloride of potassium, magnesium, calcium, ammonium, or a mixture thereof. Preferably, the non-sodium chloride salt is potassium chloride, magnesium chloride, or a mixture thereof. More preferably, the non-sodium chloride salt is potassium chloride.

The salt compositions of the present invention contain from about 10 to about 90% by weight of sodium chloride and from about 90 to 10% by weight of a non-sodium chloride. The salt compositions of the present invention may contain from about 20, 30, 35, 40, 45, 50, 55, 60, 65, or 70% by weight of sodium chloride and from about 80, 70, 65, 60, 55, 50, 45, 40, 35, or 30% by weight of a non-sodium chloride. Preferably, the salt compositions of the present invention contain about 50% by weight of sodium chloride and about 50% by weight of a non-sodium chloride.

The salt compositions of the present invention may optionally include additives which may be added before or after processing the mixture. Suitable additives include anti-caking agents, antioxidants, phosphates, colorants, dietary supplements, other ingredients typically present in table salt and salt substitute products and mixtures thereof. For instance, anti-caking agents may be included in the salt composition of the present invention to prevent caking. Anti-caking agents are added to provide a free flowing product. Exemplary anti-caking agents include, but are not limited to, sodium hexacyanoferrate (II) (YPS), potassium hexacyanoferrate (II) tri hydrate (potassium ferrocyanide or YPP), tricalcium phosphate carbonate, magnesium carbonate, silicates, propylene glycol and silicon dioxide. The anti-caking agent can be added in an amount sufficient to prevent formation of lumps or to keep the composition in free flowing form. Preferably, the anti-caking agent used is silicon dioxide. In one aspect of the present invention from about 0.1% to about 2% by weight of silicon dioxide may be added to the composition, preferably about 1% by weight of silicon dioxide.

Suitable additives also include, for example, antioxidants, to reduce the rancidity of the salted products when cooked, phosphates, to tenderize the salted food product, colorants, to give the salt composition a distinct color and dietary supplements, to support a nutritious diet. Suitable antioxidants include rosemary extract, butylated hydroxytoluene, butylated hydroxyanisole, and tocopherols, among others. Suitable phosphates include monosodium phosphate, tetrasodium pyrophosphate, sodium hexametaphosphate, monopotassium phosphate, tetrapotassium pyrophosphate, disodium phosphate, sodium tripolyphosphate, sodium acid pyrophosphate, dipotassium phosphate, and potassium tripolyphosphate. Suitable natural colorants include caramel color, turmeric, annatto, beta-carotene, paprika oleoresin, red cabbage juice, beet juice, grape skin extract, and carmine, among others. Alternatively, the antioxidant used may also act as a colorant. Suitable dietary supplements include vitamins, minerals, herbs or other botanicals, amino acids, substances such as enzymes, organ tissues, glandulars, metabolites, and combinations thereof. Preferably, the salt compositions of the present invention include magnesium chloride, vitamin D and calcium as dietary supplements. All types of magnesium, vitamin D and calcium are contemplated. Preferably, the salt compositions of the present invention include magnesium chloride.

The salt compositions of the present invention may optionally contain other ingredients typically present in table salt and salt substitute products. Other suitable ingredients include iodide sources, flavors and flavor enhancers. An exemplary iodide source is KI with a dextrose stabilizer. Exemplary flavor enhancers include monosodium glutamate (MSG), meat extracts, protein hydrolysates, hydrolyzed vegetable protein, autolyzed yeast and monomucleotide salts.

### III. METHODS OF PREPARATION

The process of making the salt compositions of the present invention includes mixing sodium chloride and a non-sodium chloride and heating the mixture to or beyond their respective melting points. Once cooled, the homogenous solution forms an amalgamation with a unique crystalline structure, that tastes like regular salt and lacks bitterness and off flavors associated with non-sodium salts.

The process includes mixing from about 10% to about 90% by weight sodium chloride and from about 90% to about 10% by weight of a non-sodium chloride. Preferably, the process includes mixing about 50% by weight sodium chloride and 50% by weight of a non-sodium chloride.

The sodium chloride is mixed with non-sodium chloride that as a dry mix. The mixing of the sodium chloride and non-sodium chloride may be conducted in any suitable vessel. After the non-sodium chloride and the sodium chloride are mixed, the dry mixture is melted at a temperature at or above their respective melting points. For instance, sodium chloride has a melting temperature of 801° C. and potassium chloride has a melting temperature of 770° C. A temperature of about 801° C. or above will melt the components. Accordingly, the heating temperature is from about 700° C. to about 1200° C. and above. A suitable heating temperature is one at which the components of the mixture will melt and form a homogeneous liquid amalgamation. Preferably, the heating temperature is about 750, 760, 770, 780, 790, 800, 805, 810, 820, 830, 840, 850, 860, 870, 880, 890, 900, 905, 910, 920, 930, 940, 950, 960, 970, 980, 990, 1000, 1010, 1025, 1050° C. or more. More preferably, the heating temperature is about 800, 801, 802, 803, 804, 805, 850, 900, 910, 950, 1000° C. More preferably, the heating temperature is about 900° C. The mixture is heated for about 1 to 60 minutes. A suitable heating time is one at which the components of the mixture will melt and form a homogeneous liquid amalgamation. Preferably, the mixture is heated for about 5, 10, 15, 20, 25, 30, 35, 40, or 45 minutes. More preferably, the mixture is heated for about 15 minutes. The mixture may be heated in any suitable vessel and oven. The time and temperature of the heating process may vary depending upon how the heat is delivered to the material.

Once the melted mixture has cooled, it may be ground or milled to the salt composition's desired particle size. Similarly to the mixing vessel, any suitable grinder or mill may be used in accordance with this invention. Alternatively, if larger particle sizes are desired the salt composition may be agglomerated or crystallized at lower temperatures.

The salt compositions may have any desired particle size. The salt compositions typically have a particle size larger than about 100 mesh, U.S. standard sieve size. Preferably, the salt compositions have a particle size of between about 35 and about 60 mesh. It should be recognized that the particle size of the composition is selected to meet the particular end use application. “Pretzel grade” salt generally has a particle size that passes through a 35 mesh sieve, whereas “shaker grade” salt has a particle size that passes through between a 35 and a 60 mesh sieve. “Popcorn grade” salt has a particle size that passes through a 60 mesh sieve. Once ground, the salt composition should have less than about 10% of all granules, which are finer than 100 mesh. All mesh sizes are by U.S. standard sieve size.

A skilled artisan will recognize that salt compositions of the present invention containing components in addition to sodium chloride and a non-sodium chloride may be prepared by several methods, including those described above. Additional methods include adding the additional components prior to heating the mixture or adding the additional components after the mixture has been heated, cooled and ground. One skilled in the art will appreciate that the method of preparation depends upon the additional components to be included in the salt composition. For instance, some components, such as organic components, will be destroyed by the high melting temperatures and may cause off flavors in the resultant product or not retain the properties or characteristics desired for inclusion in the salt composition. Some components, such as inorganic components, may not be altered by the high melting temperatures and may advantageously be included prior to the heating step. An advantage to including additional components prior to the heating step is that the additional component will be included in the homogeneous amalgamation of sodium chloride and non-sodium chloride.

### IV. METHODS OF USE

The salt compositions of the present invention may be used as a salt substitute in food products, as a table salt, or in spice mixtures. Additionally, the salt compositions of the present invention can be used in commercial food manufacturing processes in order to reduce the proportion of sodium in the product without, at the same time, decreasing the salty taste. Representative foods include soups, sauces, vegetables, meat, poultry, fish, cheese, breads, frozen foods, canned foods and snack foods, such as potato chips, pretzels, peanuts, seeds, corn chips, tortilla chips, popcorn, crackers and bread sticks. The salt compositions are applied to the foods in amounts sufficient to provide the saltiness desired.

Further, a food product containing the salt compositions of the invention is contemplated. The food product containing the salt compositions of the invention may further contain dietary supplements or flavoring agents.

A skilled artisan will recognize that the taste aspect is very important with food production. Foods, in which the sodium content is reduced, frequently lose their taste and are regarded as tasteless by the consumer. A bitter character also frequently arises due to the use of other salts. Use of the salt composition of the invention minimizes, if not completely abolishes, these effects.

The following examples are simply intended to further illustrate and explain the present invention. The invention, therefore, should not be limited to any of the details in these examples.

### EXAMPLES

### Example 1

### Making Sodium Chloride & Potassium Chloride Salt Composition

One of the salt compositions of the invention contains sodium chloride and potassium chloride without additional modifiers to mask the off flavors associated with the use of non-sodium chloride. The salt compositions of the prior art add modifiers when non-sodium chloride is used, to mask the off flavors associated with non-sodium chloride in dry mixtures or agglomerations (FIG. 1A-C). The salt composition of the present invention contains melted sodium chloride and melted potassium chloride, where each component was heated together to or beyond their respective melting point to result in an amalgamation of sodium/potassium chloride that surprisingly lacks the off flavors associated with potassium chloride (FIG. 1D).

The salt composition of the invention was made as follows. Powdered potassium chloride was mixed in a ratio of 1:1 with powdered sodium chloride. The mixture was then heated in a muffle furnace to a temperature of 900° C. for 15 minutes in small crucibles. The mixture melted to a clear liquid and then cooled in the crucibles. The melted mixture cooled into a solid form and was ground in an Udy Cyclone Mill through a 1 mm screen (UDY Corporation, 201 Rome Court, Fort Collins, Colo. 80524).

### Example 2

### Characterization of Salt Composition

The salt composition made in Example 1 was analyzed to determine its inherent properties. Specifically, the salt composition was analyzed using x-ray diffraction techniques, scanning electron microscopy, and sensory tests.

Using x-ray diffraction techniques, the salt composition of Example 1 (FIG. 2F, NaCl+KClₕₘ) was determined to have a typical diffraction pattern. In comparison to sodium chloride (FIG. 2A), potassium chloride (FIG. 2B), dry mixture of sodium chloride and potassium chloride (FIG. 2C), superheated sodium chloride (FIG. 2D), and superheated potassium chloride (FIG. 2E), the composition of Example 1 (FIG. 2F) was not unlike the simple blend of NaCl+KCl that was not heated (FIG. 2C). These results confirmed that the superheating process did not change the underlying spectra of the sodium chloride and potassium chloride. However, the superheating resulted in the removal of potassium chloride off flavors and metallic taste due to the intimate co-mingling of the two mineral salts into a homogeneous amalgamation.

Scanning electron microscopy techniques were used to analyze the macro-structure of the salt composition of Example 1 (FIG. 6) in comparison with sodium chloride (FIG. 3), potassium chloride (FIG. 4), and a dry mixture of potassium chloride and sodium chloride (FIG. 5). Comparison of sodium chloride, potassium chloride, the dry mixture, and the composition of Example 1 at the same magnification showed that the salt composition of Example 1 has a completely different shape and size than the other samples. This unique crystal shape/appearance confirms that the two mineral salts were homogenously co-mingled through the process of superheating. This unique homogenous co-mingled amalgamation of sodium and potassium ions allows these ions to be presented to the taste buds in a way that the bitterness of potassium ion is eliminated while keeping the saltiness attribute.

### Example 3

### Sensory Evaluation of Salt Composition

Sensory tests were conducted to analyze the taste characteristics of the salt composition of Example 1 in comparison with salt substitutes known in the art. Sensory tests were conducted using chicken soup stock made with either the salt substitute of Example 1 (MP-Salt Composition), a reduced sodium salt composition containing flavorants (CM Salt), or a commercially available table salt (Table Salt). The CM Salt contained sodium chloride, potassium chloride, and modifiers used to mask the bitterness associated with potassium chloride.

A chicken soup stock was made by mixing a base chicken broth (Pacific Organic Free Range Low Sodium Chicken Broth) and 2.5%, by weight Chicken Broth Paste C1201 from Proliant Ingredients. The soup stock was then heated to 150° F. before the individual salt compositions (1.5%, by weight) were added. The salt/soup mixture was thoroughly blended to be sure the salt was in solution. The salt/soup mixture was poured into a coffee carafe until needed. Samples were used within the next 5 minutes. Samples were served for an hour and the temperature stayed constant.

Samples were served one at a time in a predetermined random order. Panelists were provided room temperature water and an unsalted cracker so they could clear their palate between samples. Data was collected using the SIMS 2000 computer system and a 15 point scale was used. A total of 37 people participated.

In regards to appearance and flavor, the results are summarized in FIG. 10. The only significant difference between the three test samples was found in the salt intensity in the flavor attributes. The table salt was significantly saltier than the CM salt. However, the composition of Example 1 was not significantly (using statistical testing) different from the table salt. All other variables also were either equal to the table salt or not significantly different.

Typically, products with high water content are difficult mediums for salt substitutes to function. The integrity of salt substitutes is hard to retain in liquid mediums because the components of the salt substitute often disassociate from each other, nullifying the advantages of using the salt substitute. However, as can be appreciated by the sensory testing, the salt substitute of the present invention can be used in liquid mediums without the components disassociating, therefore imparting the advantages of using low sodium salt substitutes even to liquid mediums.

### Example 4

### Making Sodium Chloride, Potassium Chloride & Magnesium Chloride Salt Composition

A salt composition of the invention containing sodium chloride, potassium chloride and magnesium chloride without additional flavorants to mask the off flavors associated with the use of potassium chloride was prepared as follows. Powdered sodium chloride, potassium chloride and magnesium chloride was mixed in a ratio of 5:4:1. The mixture was then heated in a muffle furnace to a temperature of about 1050° C. for about 15 minutes in small crucibles. The mixture melted to a clear liquid and then cooled in the crucibles. The melted mixture cooled into a solid form and was ground using a mortar and pestle into a fine powder.

### Example 5

### Characterization of Salt Composition

The salt composition made in Example 4 was analyzed to determine its inherent properties. Specifically, the salt composition was analyzed using scanning electron microscopy and sensory tests.

Scanning electron microscopy techniques were used to analyze the macro-structure of the salt composition of Example 4 (FIGS. 8 and 9) in comparison with a dry mixture of sodium chloride, potassium chloride and magnesium chloride (FIG. 7). Comparison of the dry mixture and the composition of Example 4 at the same magnification showed that the salt composition of Example 4 has a completely different shape and size than the dry mixture sample. Further, each individual component is identifiable in the dry mixture under magnification, while each individual component is not identifiable in the composition of Example 4.

Preliminary sensory tests indicate that the composition of Example 4 has superior “salt” taste and color attributes. In particular, the salt taste and color of Example 4 are indistinguishable from table salt.

The invention illustratively disclosed herein suitably may be practiced in the absence of any element, which is not specifically disclosed herein. It is apparent to those skilled in the art, however, that many changes, variations, modifications, other uses, and applications to the method are possible, and also changes, variations, modifications, other uses, and applications which do not depart from the spirit and scope of the invention are deemed to be covered by the invention, which is limited only by the claims which follow.

What is claimed is:

1. A salt composition comprising an amalgamation of sodium chloride and a non-sodium chloride, wherein the amalgamation is formed by heating a mixture of sodium chloride and the chloride to at least 700° C.

2. The salt composition of claim 1, wherein the chloride is selected from the group consisting of potassium, magnesium, calcium, ammonium, or a mixture thereof.

3. The salt composition of claim 2, wherein the chloride is potassium chloride.

4. The salt composition of claim 2, wherein the chloride is potassium chloride and magnesium chloride.

5. The salt composition of claim 1, further comprising an additive selected from the group consisting of an antioxidant, a dietary supplement, a phosphate, an anti-caking agent, a colorant, and combinations thereof.

6. The salt composition of claim 5, wherein the additive is an antioxidant.

7. The salt composition of claim 5, wherein the additive is a dietary supplement.

8. The salt composition of claim 8, wherein the dietary supplement is selected from the group consisting of vitamin, mineral, herb, botanical, enzyme, metabolite and combinations thereof.

9. The salt composition of claim 5, wherein the additive is an anti-caking agent.

10. The salt composition of claim 1, wherein the composition contains about 10-90%, lower sodium than regular salt.

11. The salt composition of claim 10, wherein the composition contains about 50% less sodium than regular salt.

12. A food product comprising the low sodium salt composition of claim 1.

13. A method of preparing a salt composition comprising:
a. mixing an amount of sodium chloride with an amount of a non-sodium chloride to create a mixture;
b. heating the mixture to a temperature that causes the mixture to melt and form an amalgamation of the mixture; and,
c. cooling the amalgamation to form a salt composition.

14. The method of claim 18, wherein the temperature is within the range of about 700 to about 1100° C.

15. The method of claim 19, wherein the temperature is selected from the group consisting of about 750, 760, 770, 775, 780, 785, 790, 795, 800, 805, 810, 815, 820, 830, 840, 850, 860, 870, 880, 890, 895, 900, 905, 910, 915, 920, 925, 930, 935, 940, 945, 950, 955, 960, 965, 970, 975, 980, 985, 990, 995, 1000, 1005, 1010, 1015, 1020, 1025, 1030, 1035, 1040, 1045, and 1050° C.

16. The method of claim 19, wherein the temperature is about 900° C.

17. The method of claim 18, wherein the heating is for a time selected from the group consisting of 5, 10, 15, 20, 25, and 30 minutes.

18. The method of claim 22, wherein the heating is for 15 minutes.

19. The method of claim 18, further comprising grinding the amalgamation to form a salt composition.

20. The method of claim 24, further comprising blending the ground amalgamation with at least one additive to form a salt composition.

21. The method of claim 25, wherein the additive is selected from the group consisting of an antioxidant, a dietary supplement, a phosphate, an anti-caking agent, a colorant, and combinations thereof.

22. The method of claim 26, wherein the additive is an antioxidant.

23. The method of claim 26, wherein the additive is a dietary supplement.

24. The method of claim 28, wherein the dietary supplement is selected from the group consisting of vitamin, mineral, herb, botanical, enzyme, metabolite and combinations thereof.

25. The method of claim 26, wherein the additive is an anti-caking agent.

26. The method of claim 18, wherein the resultant salt composition contains about 10-90%, lower sodium than regular salt.

27. The method of claim 31, wherein the resultant salt composition contains about 50% less sodium than regular salt.
